(19) United States
(12) Patent Application Publication
(10) Pub. No.: US 2025/0372315 A1
(43) Pub. Date: Dec. 4, 2025

(54) Nickel Cobalt Sulfoselenide Bitransition Mixed Chalcogenide for Use as Supercapacitor

(71) Applicant: Amrita Vishwa Vidyapeetham, Coimbatore (IN)

(72) Inventors: Charis S. Caroline, Tamil Nadu (IN); Sudip K. Batabyal, Coimbatore (IN)

(73) Assignee: Amrita Vishwa Vidyapeetham, Coimbatore (IN)

(21) Appl. No.: 18/902,365

(22) Filed: Sep. 30, 2024

(30) Foreign Application Priority Data
May 29, 2024 (IN) 202441041758

(51) Int. Cl. H01G 11/30; C01B 19/00; H01G 11/24; H01G 11/86

(52) U.S. Cl. CPC H01G 11/30; C01B 19/002; H01G 11/24; H01G 11/86; C01P 2002/22; C01P 2002/50; C01P 2002/72; C01P 2002/74; C01P 2002/78; C01P 2002/82; C01P 2006/12; C01P 2006/14; C01P 2006/16; C01P 2006/40

(57) ABSTRACT

A bitransition mixed chalcogenide, nickel cobalt sulfoselenide/nickel sulfoselenide mixed chalcogenide for use as supercapacitor and method of fabrication of nickel cobalt sulfoselenide/nickel sulfoselenide material is disclosed. The nickel cobalt sulfoselenide mixed chalcogenide comprises Ni₁Co₁₋ₓSSe, where nickel and cobalt are in ratios of 6:4, 4:6, 5:5, 0:10, or 10:0 forming Ni_{0.6}Co_{0.4}SSe, Ni_{0.4}Co_{0.6}SSe, Ni_{0.5}Co_{0.5}SSe CoSSe or NiSSe. The supercapacitor electrode formed from Ni_{0.6}Co_{0.4}SSe gives a specific capacitance of 464 Fg⁻¹ with a current density of 1 Ag⁻¹ and NiSSe electrode gives a specific capacitance of 1908 Fg⁻¹ with a current density of 1 Ag⁻¹. The method (100) includes providing Ni(NO₃)₂·6H₂O and Co(NO₃)₂·6H₂O in different ratios, adding (104) NaOH and Na₂S flakes and grinding to form a mixture, adding (106) ethylene glycol and selenium powder and homogenizing the mixture, heating (108) at 180° C. and washing with ethanol and drying at about 60° C. for 36 hrs to obtain a fine powder.

### BACKGROUND OF THE INVENTION

### Field of the Invention

The invention generally relates to mixed chalcogenides to address layer stacking constraints, and in particular to binary metal mixed chalcogenides and its electrochemical performance to advance supercapacitor technology.

### Description of the Related Art

Renewable energy technologies have witnessed a remarkable surge in popularity on a global scale. As the demand for sustainable and clean energy solutions continues to grow, it becomes increasingly essential to delve into the latest advancements in this field. As the need for portable electronics and sustainable energy solutions continues to rise, the significance of energy storage technologies in empowering our contemporary society grows exponentially. Energy storage is an indispensable component in the functionality of supercapacitors and batteries. Its primary purpose is to facilitate the effective acquisition and discharge of energy, thereby ensuring the seamless and dependable operation of various devices. These innovative advancements are instrumental in meeting the ever-increasing energy demands of our modern world. Batteries, despite their low power density, are not suitable for situations that require a massive surge of current at a specific moment in time. On the other hand, supercapacitors possess a high power density, infinite charge-discharge cycles, and long lifespan. Energy storage plays a crucial role in the functionality of both supercapacitors and batteries. Its main objective is to enable efficient energy acquisition and discharge, ensuring the smooth and reliable operation of various devices. A pseudocapacitor realizes the energy through intercalation. By the reversible inclusion into the material charges are stored, there is a surface redox reaction that takes place and there is no phase transition. Due to the redox reactions, this allows for large capacitance. Metal chalcogenides in general show this type of pseudocapacitive behavior. Transition metal chalcogenides are a viable contender for pseudocapacitors due to the fast redox mechanism in the metal chalcogenides.

Battery-type materials, such as transition metal-based compounds, allow for interfacial redox reactions and offer higher specific capacitance. The transition metals can change the oxidation state of the metal sites present in the chalcogenide. This allows for the effective redox reactions to take place and also for the effective increase in the capacitance. Mono transition metal chalcogenides have significant spot in electrochemical energy storage. They have a low electrical conductivity, low cyclic stability and inferior coulombic efficiency. Bitransition-based supercapacitors are preferred due to the synergistic effect of the metal ions present. It gives good access to the active species.

The high electrical conductivity of selenides in addition to other complementary properties like fast electron transfer. The electrical conductivity of the binary metals is also reportedly high compared to its singular counterparts. Amongst the various transition metals, nickel and cobalt have been extensively researched by several research groups. Both nickel and cobalt have multiple oxidation states, which paves way to multiple redox active sites. They have fast reaction kinetics, superior chemical activity and fast redox behavior. Although chalcogenides have a superior market in the commercial arena, it is best put to use when two chalcogenides are used in combination. The electrical conductivity, volumetric capacity, gravimetric capacitance, etc. can be an added advantage.

2D Van der Waals structures has gained large attention due to the excellent possibility of attaining high specific capacitance, large interlayer spacing and ease of synthesis. Intrinsically, such structures suffer from stacking up of layers which are a hindrance for movement of the electrolyte ions. To address this issue effectively while maximizing complementary effects among multiple elements involved in the composition of the 2D heterostructure may reveal intriguing electrochemical phenomena. The novel strategy of bringing in multiple elements can support the performance. It not only reduces the internal resistance by leveraging cooperative influence from two different metal species and chalcogenides results in improved capacitance.

Researchers have taken significant interest on mixed chalcogenides in the recent past. Various publications reported the use of mixed chalcogenides. Mingjie Yi et al. reported In-situ confined conductive nickel cobalt sulfoselenide with tailored composition in graphitic carbon hollow structure for energy storage. Z. Zhang et al. reported construction of hierarchical NiCoSe@CoS core-shell nanotube arrays for high-performance hybrid supercapacitor. K. P. Annamalai et al. reported construction of indigenous tin incorporated nickel dichalcogenide nanosheets for high energy all solid-state hybrid supercapacitor. An improved mixed chalcogenide material showing improved electrochemical performance and supercapacitance and simple one-step synthesis of the material is disclosed.

### SUMMARY OF THE INVENTION

The present subject matter discloses a bitransition mixed chalcogenide, nickel cobalt sulfoselenide mixed chalcogenide for use as supercapacitor.

According to one embodiment of the present subject matter, nickel cobalt sulfoselenide mixed chalcogenide comprises of Ni₁Co₁₋ₓSSe, where nickel and cobalt are in ratios of 6:4, 4:6, 5:5, 0:10, or 10:0 forming Ni_{0.6}Co_{0.4}SSe, Ni_{0.4}Co_{0.6}SSe, Ni_{0.5}Co_{0.5}SSe CoSSe or NiSSe. The sulfoselenides have a 2D Van der Waals layered structure of nanosheets with d-spacing in the range of 3 Å and 7 Å. The pore radius of the chalcogenide varies from 50 Å to 120 Å. The nickel cobalt sulfoselenide mixed chalcogenide, Ni_{0.6}Co_{0.4}SSe gives XRD peaks at 22.15°, 26.31°, 27.55°, 41.52°, 45.08°, 52.41°, 60.69°, 64.73° and 66.93°. The nickel cobalt sulfoselenide mixed chalcogenide, Ni_{0.6}Co_{0.4}SSe has a pore radius of 66.21 Å and a pore volume of 0.5381 ccg⁻¹ or more.

The nickel cobalt sulfoselenide mixed chalcogenide, Ni_{0.6}Co_{0.4}SSe has a surface area of 171.878 m²g⁻¹ or more. The nickel cobalt sulfoselenide mixed chalcogenide have surface areas of Ni_{0.4}Co_{0.6}SSe, Ni_{0.5}Co_{0.5}SSe and Ni₀Co_{1.0}SSe are 6.624 m²g⁻¹, 6.431 m²g⁻¹ and 5.525 m²g⁻¹ respectively. The nickel cobalt sulfoselenide mixed chalcogenide, NiSSe gives XRD peaks at 19.55°, 20.30°, 22.17°, 27.19°, 30.50°, 59.05°.

According to some embodiments, a supercapacitor electrode based on nickel cobalt sulfoselenide is disclosed. The supercapacitor electrode comprises powdered Ni₁Co₁₋ₓSSe having narrow pore size distribution transformed into an ink, and using carbon cloth or nickel foam as substrate. The supercapacitor Ni₁Co₁₋ₓSSe electrode formed from Ni_{0.6}Co_{0.4}SSe gives a specific capacitance of 464 Fg⁻¹ with a current density of 1 Ag⁻¹. The supercapacitor electrode, Ni_{0.6}Co_{0.4}SSe fabricated coin cell exhibits a retention rate of 99% for 30,000 cycles at a rate of 5 Ag⁻¹ and 87.54% retention over 60,000 cycles at a rate of 10 Ag⁻¹.

According to some embodiments, the supercapacitor Ni₁Co₁₋ₓSSe electrode formed from NiSSe gives a specific capacitance of 1908 Fg⁻¹ with a current density of 1 Ag⁻¹ using PVA/KOH gel electrolyte and a specific capacitance of 259 Fg⁻¹ at a current density of 25 Ag⁻¹ and a capacitance retention of 95% after 10,000 charge-discharge cycles at 25 Ag⁻¹. The supercapacitor Ni_{0.6}Co_{0.4}SSe electrode has a shelf life after two years with a capacitance retention of 93% for over 1,00,000 cycles. The supercapacitor NiSSe electrode has a shelf life, with 100% retention after 3000 cycles at 10 A/g, of 100 days.

According to some embodiments, a method of fabrication of nickel cobalt sulfoselenide/nickel sulfoselenide material is disclosed. The method includes providing Ni(NO₃)₂·6H₂O and Co(NO₃)₂·6H₂O in different ratios and adding 4 g of NaOH and 300 mg of Na₂S flakes and grinding to form a mixture. The method includes adding ethylene glycol and selenium powder to form a mixture and homogenizing the mixture by grinding. The method next includes heating the homogenized mixture at 180° C. for about 6 hours and washing with double distilled water and ethanol. The method includes drying at about 60° C. for 36 hrs to obtain a fine powder. The Ni(NO₃)₂·6H₂O and Co(NO₃)₂·6H₂O are taken in ratios 6:4, 4:6, 5:5, 0:10 and 10:0 to obtain the products Ni_{0.6}Co_{0.4}SSe, Ni_{0.4}Co_{0.6}SSe, Ni_{0.5}Co_{0.5}SSe, CoSSe and NiSSe for 6:4, 4:6, 5:5, 0:10 and 10:0 respectively.

### BRIEF DESCRIPTION OF THE DRAWINGS

FIG. 1 illustrates the steps involved in the fabrication of nickel cobalt sulfoselenide/nickel sulfoselenide material.

FIG. 2A shows the XRD analysis of the nickel cobalt sulfoselenides Ni_{0.6}Co_{0.4}SSe, Ni_{0.4}Co_{0.6}SSe, Ni_{0.5}Co_{0.5}SSe and Ni₀Co_{1.0}SSe.

FIG. 2B shows the Raman analysis of the nickel cobalt sulfoselenides.

FIG. 3A shows the XRD peaks obtained for nickel sulfoselenides NiSSe1, NiSSe2, and NiSSe3.

FIG. 3B shows the peaks obtained from Raman analysis for the nickel sulfoselenides NiSSe1, NiSSe2, and NiSSe3.

FIG. 4A shows the CV curves for Ni_{0.6}Co_{0.4}SSe, Ni_{0.4}Co_{0.6}SSe, Ni_{0.5}Co_{0.5}SSe and Co_{1.0}SSe.

FIG. 4B illustrates the specific capacitance values calculated from the CV curve for the four samples Ni_{0.6}Co_{0.4}SSe, Ni_{0.4}Co_{0.6}SSe, Ni_{0.5}Co_{0.5}SSe and Ni₀Co_{1.0}SSe.

FIG. 4C shows the GCD curve for Ni_{0.6}Co_{0.4}SSe, Ni_{0.4}Co_{0.6}SSe, Ni_{0.5}Co_{0.5}SSe and Ni₀Co_{1.0}SSe.

FIG. 4D illustrates the specific capacitance calculated for the nickel cobalt sulfoselenides from the GCD curve.

FIG. 5A shows the specific capacitance values at 10 mVs⁻¹ sweep rate for nickel sulfoselenides NiSSe1, NiSSe2, and NiSSe3.

FIG. 5B shows the electrical conductivity of the nickel sulfoselenides NiSSe1, NiSSe2, and NiSSe3.

FIG. 6A shows the CV curve of asymmetric Ni_{0.6}Co_{0.4}SSe coin cell at different scan rates and FIG. 6B shows the GCD curve of asymmetric Ni_{0.6}Co_{0.4}SSe coin cell at different current densities

FIG. 6C shows the capacitance calculated at different current densities for asymmetric Ni_{0.6}Co_{0.4}SSe coin cell.

FIG. 7A shows the specific capacitance measurements at different scan rates for NiSSe1 coin cell.

FIG. 7B shows the GCD curve of NiSSe1 coin cell at 1 Ag⁻¹.

FIG. 7C shows the specific capacitance calculated from the GCD curve of NiSSe1 coin cell at different current densities.

### DETAILED DESCRIPTION OF THE EMBODIMENTS

While the invention has been disclosed with reference to certain embodiments, it will be understood by those skilled in the art that various changes may be made and equivalents may be substituted without departing from the scope of the invention. In addition, many modifications may be made to adapt to a particular situation or material to the teachings of the invention without departing from its scope.

Throughout the specification and claims, the following terms take the meanings explicitly associated herein unless the context clearly dictates otherwise. The meaning of “a”, “an”, and “the” include plural references. The meaning of “in” includes “in” and “on.” Referring to the drawings, like numbers indicate like parts throughout the views. Additionally, a reference to the singular includes a reference to the plural unless otherwise stated or inconsistent with the disclosure herein.

The present subject matter describes a bitransition metal mixed chalcogenide, fabrication of the mixed chalcogenide as supercapacitor and method of preparation of the bitransition metal mixed chalcogenide.

The invention in various embodiments discloses a nickel cobalt sulfoselenide mixed chalcogenide for use as supercapacitor. The nickel cobalt sulfoselenide has a formula Ni₁Co₁₋ₓSSe, where nickel and cobalt are in ratios of 6:4, 4:6, 5:5, or 0:10 or 10:0 forming Ni_{0.6}Co_{0.4}SSe, Ni_{0.4}Co_{0.6}SSe, Ni_{0.5}Co_{0.5}SSe, CoSSe or NiSSe respectively. The sulfoselenides have a 2D Van der Waals layered structure of nanosheets with d-spacing in the range of 3 Å and 7 Å. The mixed chalcogenide Ni_{0.6}Co_{0.4}SSe gives XRD peaks at 22.15°, 26.31°, 27.55°, 41.52°, 45.08°, 52.41°, 60.69°, 64.73° and 66.93°. According to one embodiment of the invention, the sulfoselenide mixed chalcogenide has a pore radius ranging from 50 Å to 120 Å. The nickel cobalt sulfoselenide mixed chalcogenide Ni_{0.6}Co_{0.4}SSe has a pore radius of 66.21 Å and a pore volume of 0.5381 ccg⁻¹ or more. The surface area of Ni_{0.6}Co_{0.4}SSe is 171.878 m²g⁻¹ or more. The surface areas of Ni_{0.4}Co_{0.6}SSe, Ni_{0.5}Co_{0.5}SSe and Ni₀Co_{1.0}SSe are 6.624 m²g⁻¹, 6.431 m²g⁻¹ and 5.525 m²g⁻¹ respectively, according to one embodiment of the invention. The nickel sulfoselenide, NiSSe gives XRD peaks at 9.55°, 20.30°, 22.17°, 27.19°, 30.50°, 59.05°.

The small pore size and high pore volume gives the mixed chalcogenide exceptional capacity to accommodate charge-storing materials. The small pore width implies efficient charge confinement within the pores. The nickel cobalt sulfoselenide, Ni_{0.6}Co_{0.4}SSe due to its pore volume, surface area, and pore characteristics, makes it an optimal choice for charge storage applications. Among the nickel sulfoselenides, NiSSe shows improved electrochemical performance. The improved electrochemical performance could be due to the formation of well-defined 2D heterostructures that are dominated by the Van der Waals force. The large d-spacing between the 2D layered structure allows for the electrolyte ions to pass in and out of the electrode without having to undergo a torturous network. The close Van der Waals interactions between the 2D layered nanosheets (2D-2D) aids in charge storage. The face-to-face stacking of the individual 2D nanosheets increases the contact area at the interface. This interfacial coupling offers more space for charge storage. As an effect of size, the ion diffusion paths are short playing a significant role in mass transfer and improved charge storage. The free assembly of the 2D nanosheets improves the electrochemical performance while offering an effective charge transfer at the 2D-2D interface.

According to one embodiment of the invention, a supercapacitor electrode based on nickel cobalt sulfoselenide mixed chalcogenide is disclosed. The supercapacitor electrode comprises powdered Ni₁Co₁₋ₓSSe, having narrow pore size distribution transformed into an ink and using carbon cloth or nickel foam as substrate. According to one embodiment of the invention, Ni₁Co₁₋ₓSSe electrode formed from Ni_{0.6}Co_{0.4}SSe gives a specific capacitance of 464 Fg⁻¹ with a current density of 1 Ag⁻¹. The Ni_{0.6}Co_{0.4}SSe fabricated coin cell exhibits a retention rate of 99% for 30,000 cycles at a rate of 5 Ag⁻¹ and 87.54% retention over 60,000 cycles at a rate of 10 Ag⁻¹. According to one embodiment of the invention, the coin cell shows increased stability and shelf life after 2 years with a capacitance retention of 93% for over 1,00,000 cycles.

According to another embodiment of the invention, the NiSSe supercapacitor electrode gives a specific capacitance of 1908 Fg⁻¹ with a current density of 1 Ag⁻¹ using PVA/KOH gel electrolyte and a specific capacitance of 259 Fg⁻¹ at a current density of 25 Ag⁻¹. According to another embodiment of the invention, the NiSSe electrode has a shelf life, with 100% retention after 3000 cycles at 10 A/g, of 100 days.

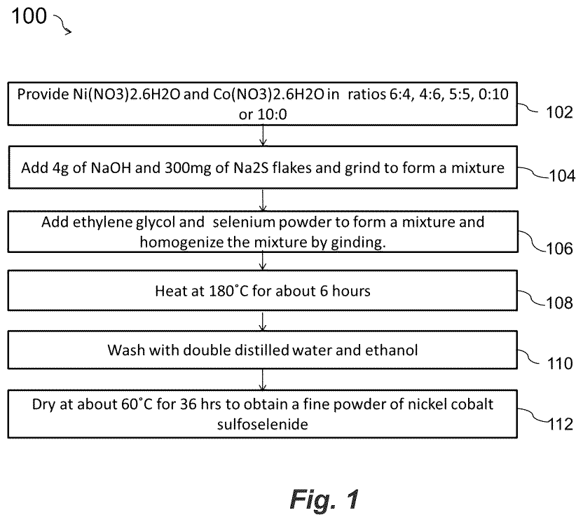

According to one embodiment of the invention, a method 100 of fabrication of nickel cobalt sulfoselenide/nickel sulfoselenide material is disclosed. FIG. 1 shows the steps involved in the method of fabrication. The method includes providing Ni(NO₃)₂·6H₂O and Co(NO₃)₂·6H₂O in different ratios at 102. The method next includes adding 4 g of NaOH and 300 mg of Na₂S flakes and grinding to form a mixture at 104. Ethylene glycol and selenium powder is added to form a mixture and the mixture is homogenized by grinding at 106. The resulting homogenized mixture is heated at at 180° C. for about 6 hours and washed with double distilled water and ethanol at 108. The product is washed with double distilled water multiple times to remove unreacted ions. The method next includes drying at about 60° C. for 36 hrs to obtain a fine powder at 110. The Ni(NO₃)₂·6H₂O and Co(NO₃)₂·6H₂O are taken in different ratios gives different products. Ni(NO₃)₂·6H₂O and Co(NO₃)₂·6H₂O taken in ratios 6:4, 4:6, 5:5, 0:10 and 10:0 gives Ni_{0.6}Co_{0.4}SSe, Ni_{0.4}Co_{0.6}SSe, Ni_{0.5}Co_{0.5}SSe, CoSSe and NiSSe respectively.

The invention in its various embodiments discloses the supercapacitor potential of 2D Van der Waals structures by introducing mixed chalcogenides to address layer stacking constraints. The potential of binary metal mixed chalcogenides to advance supercapacitor technology is disclosed. The specific capacitance is improved by selenium and sulfur, and electrochemical properties are further enhanced by cobalt through a simpler one-step synthesis. Nickel cobalt sulfoselenide, Ni_{0.6}Co_{0.4}SSe and nickel sulfoselenide, NiSSe exhibited better electrochemical performance and showcased remarkable stability and high retention rates over an extensive number of charge-discharge cycles making the bitransition mixed chalcogenides a promising material for high-performance energy storage devices.

### EXAMPLES

### Example 1: Characterisation of the Sulfoselenide Mixed Chalcogenides

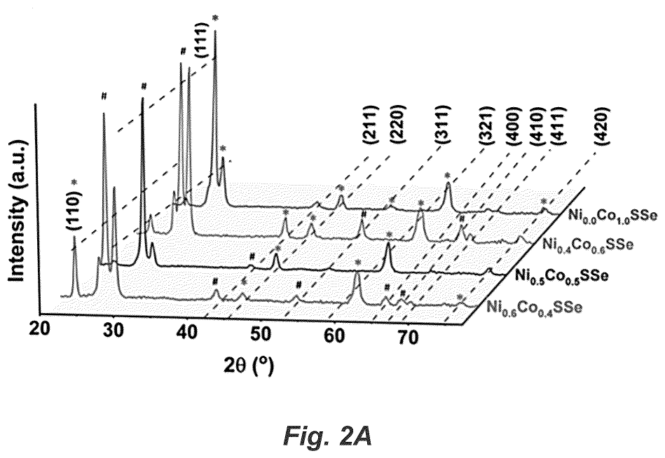

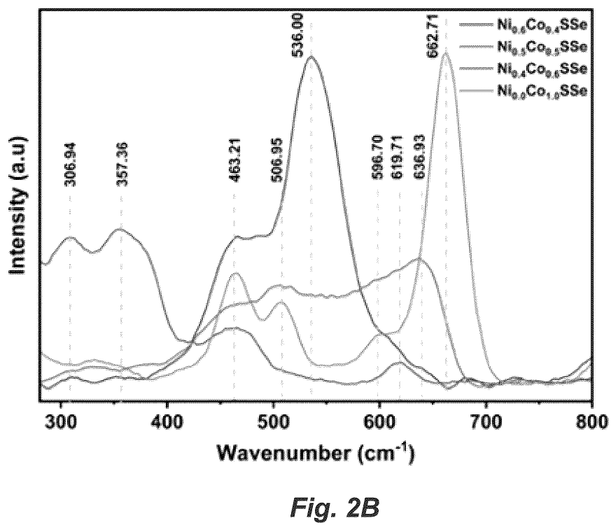

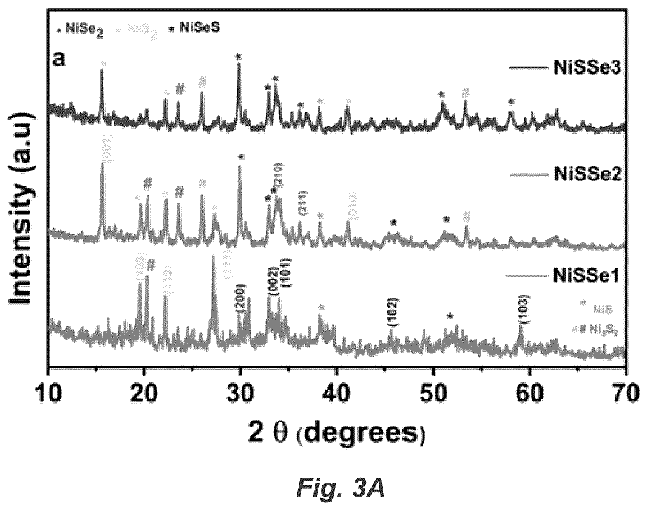

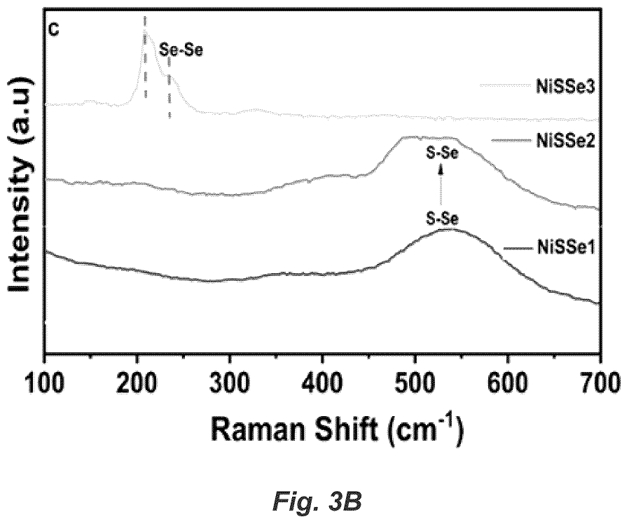

FIG. 2A shows X-ray diffraction analysis of the nickel cobalt sulfoselenide. The X-Ray Diffraction analysis confirms the incorporation of nickel and cobalt. The Ni_{0.6}Co_{0.4}SSe, Ni_{0.4}Co_{0.6}SSe, Ni_{0.5}Co_{0.5}SSe, CoSSe and NiSSe were analyzed. The planes (110), (111), (211), (220), (311), (321), (400), (410), (411) and (420) correspond to both nickel sulfoselenide and cobalt sulfoselenide. The co-existence of cubic phase of nickel sulfoselenide and cobalt sulfoselenide contributes to the electrochemical performance. The XRD confirms that even with the variation of nickel and cobalt precursor ratio, due to the effect of the reaction procedure nickel sulfoselenide and cobalt sulfoselenide has been formed with no secondary peaks. It can be evidenced from CoSSe that only cobalt sulfoselenide peaks can be seen. The growth axis is the varying factor in all the four samples and that along with other factors is expected to affect the performance. The nickel sulfoselenides NiSSe1, NiSSe2, and NiSSe3 for 1, 2, and 3 mols of Se respectively, were analysed by X-Ray Diffraction. The XRD pattern is as shown in FIG. 3A. The X-ray diffractogram shows the formation of multiphase of nickel sulfide-nickel sulfoselenide. The sulfur in the nickel sulfide is partly replaced as selenium is incorporated in molar ratios of 1, 2 and 3. Due to the insolubility of selenium in water, sodium sulfide flakes were used as a precursor to synthesize nickel sulfide-nickel sulfoselenide. Since the selenium is incorporated in molar ratios during the reaction process only some part of sodium sulfide flakes is converted to nickel sulfoselenide while the other remains as nickel sulfide. This creates an added interaction between nickel sulfide (X-M-X) and nickel sulfoselenide (X-M-X′). Thus a composite of nickel sulfide and nickel sulfoselenide is formed. In NiSSe1 there exists a mixed composition of nickel sulfoselenide and nickel sulfide.

The nickel cobalt sulfoselenide samples were tested for Raman analysis as shown in FIG. 2B. The Raman modes can be observed in four areas as 300-370 cm⁻¹, 450-500 cm⁻¹, 500-550 cm⁻¹, 590-670 cm⁻¹. The interactions between the metal and chalcogenides, S—Se, S—S and Se—Se are seen. With the highest content of cobalt there is a shift in the Raman spectra to 662.71 cm⁻¹, with two other peaks at 463.21 cm⁻¹ and 506.95 cm⁻¹. There is a shoulder peak of 536 cm⁻¹ at 463.21 cm⁻¹ in Ni_{0.6}Co_{0.4}SSe. The shoulder peak exists as a sharp one in case of Ni_{0.0}Co_{1.0}SSe, this may be due to the absence of nickel content and the existence of sulfur. It exists as a hump in case of Ni_{0.4}Co_{0.6}SSe, in addition to this there are two other peaks at 306.94 cm⁻¹ and 357.36 cm⁻¹. This may be due to the vibration related to the S—Se bond. All the samples of nickel sulfoselenide, NiSSe1, NiSSe2, and NiSSe3 were analysed by Raman analysis as shown in FIG. 3B. The ratio of sulfur and selenium plays a vital role in determining the vibrational spectra. Raman spectra are sensitive to the substitutional doping of selenium in sulfur. The complex behavior of the material has several modes that can be assigned to S—S, S—Se, and Se—Se bonds. With the increase in the Se concentration, the stretching pair of S—S which is absent in the 475-550 cm⁻¹ range of NiSSe2 becomes broad band with an increase in Se doping. In the case of NiSSe3, this peak is not observed as the material has only the Se—Se mode of vibration. The intense peak corresponding to Se—Se mode of vibration is absent in NiSSe2. The S—S modes that are prominent between 150 and 450 cm⁻¹ are also not observed when Se is incorporated.

The morphological analysis of Ni_{0.6}Co_{0.4}SSe, Ni_{0.4}Co_{0.6}SSe, Ni_{0.5}Co_{0.5}SSe and Ni₀Co_{1.0}SSe were done using FESEM. The Ni_{0.4}Co_{0.6}SSe, Ni_{0.6}Co_{0.4}SSe, Ni_{0.5}Co_{0.5}SSe and Ni₀Co_{1.0}SSe samples showed stacked flake like, 2D crumbled sheet like, fused structures and highly agglomerated morphology respectively. The sample Ni_{0.6}Co_{0.4}SSe is expected to have a relatively high surface area based on the FESEM images. Further morphological analysis were done for NiS, NiSSe1, NiSSe2, and NiSSe3 to understand the improved electrochemical performance. The FESEM analyses of NiSSe1, NiSSe2, and NiSSe3 show 2D sheet-like, microcrystals and large fused cube morphology. The higher electrochemical performance as observed in the cyclic voltammetry could be due to the formation of sheets in case of NiSSe1.

BET (Brunauer-Emmett-Teller) analysis on four samples Ni_{0.6}Co_{0.4}SSe, Ni_{0.4}Co_{0.6}SSe, Ni_{0.5}Co_{0.5}SSe and Ni₀Co_{1.0}SSe were done with a focus on identifying the most suitable sample for charge storage applications. Amongst all the samples, Ni_{0.6}Co_{0.4}SSe shows a peculiar BET curve. It shows a type II isotherm curve. The adsorption desorption path confirms that Ni_{0.6}Co_{0.4}SSe sample has excellent structural stability. During the adsorption desorption process, the structure has not collapsed confirming that the material can be considered stable even during the ion intercalation and deintercalation process. The pore radius of the samples Ni_{0.6}Co_{0.4}SSe, Ni_{0.4}Co_{0.6}SSe, Ni_{0.5}Co_{0.5}SSe and Ni₀Co_{1.0}SSe varies as 66.21 Å, 80.12 Å, 106.9 Å and 108.56 Å. The multi-point BET data reveals that as expected Ni_{0.6}Co_{0.4}SSe sample has an ultra-high surface area of 171.878 m²g⁻¹. The other samples have a surface area of 6.624 m²g⁻¹, 6.431 m²g⁻¹ and 5.525 m²g⁻¹ for Ni_{0.4}Co_{0.6}SSe, Ni_{0.5}Co_{0.5}SSe and Ni₀Co_{1.0}SSe respectively. The small pore size, the stability of the nanostructure and the higher pore volume of 0.5381 ccg⁻¹ indicated an exceptional capacity to accommodate charge-storing materials in Ni_{0.6}Co_{0.4}SSe. Moreover, the impressively large surface area of 171.878 m²g⁻¹, provides ample room for charge adsorption and desorption processes. Ni_{0.6}Co_{0.4}SSe offers a conducive environment for charge retention and stability. The smaller half pore width of 8.828 Å in Ni_{0.6}Co_{0.4}SSe implies efficient charge confinement within the pores. It is evident that Ni_{0.6}Co_{0.4}SSe outshines the other samples in terms of pore volume, surface area, and pore characteristics, making it the optimal choice for charge storage applications, where maximizing capacity, stability and precision are paramount.

### Example 2: Electrochemical Measurements and Specific Capacitance Measurements of Samples

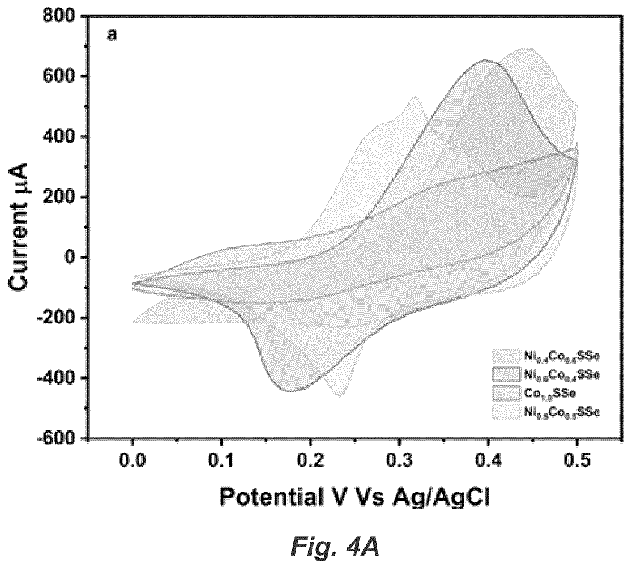

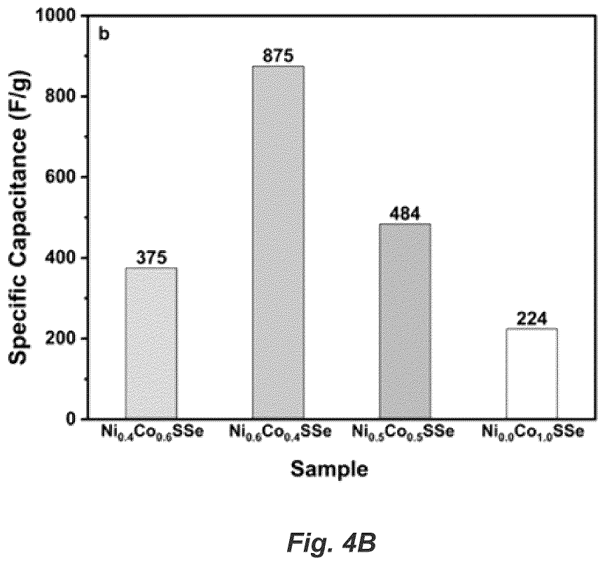

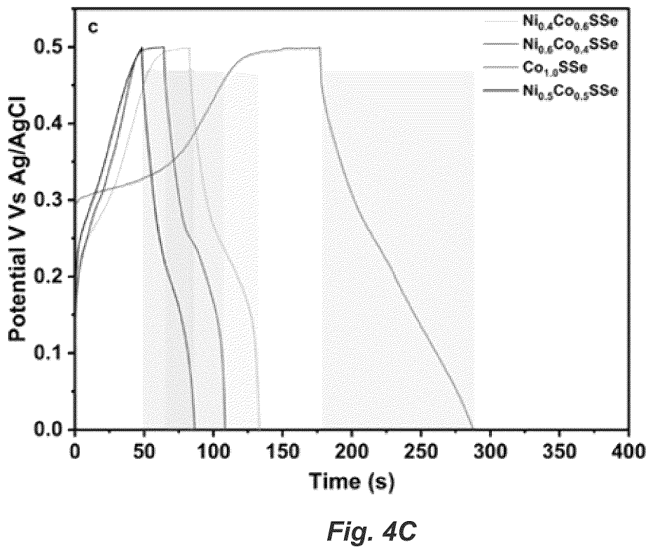

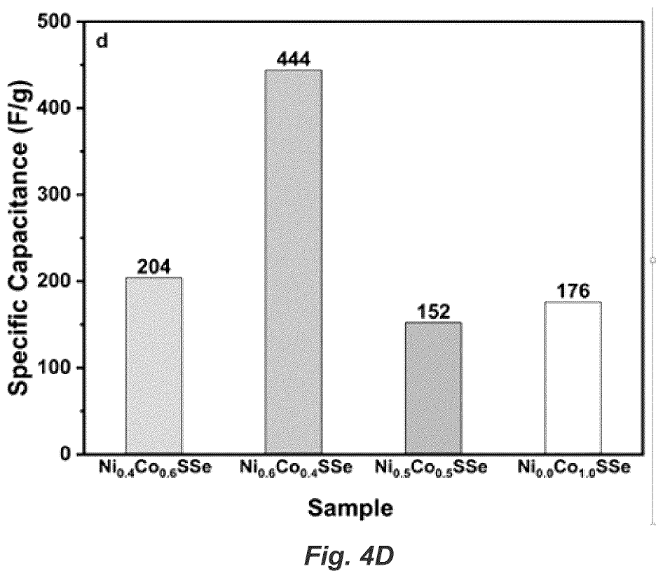

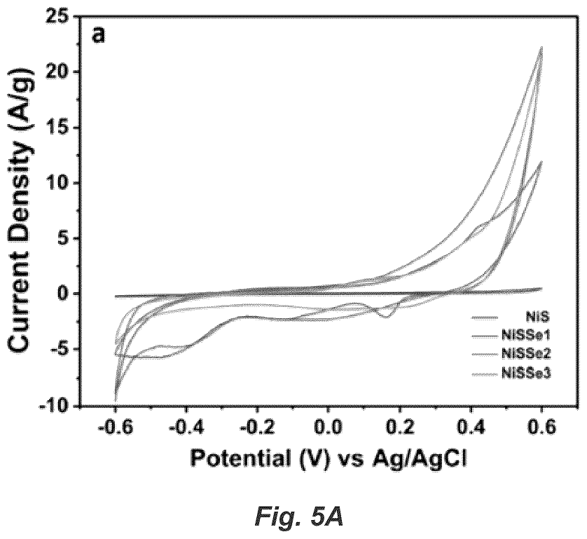

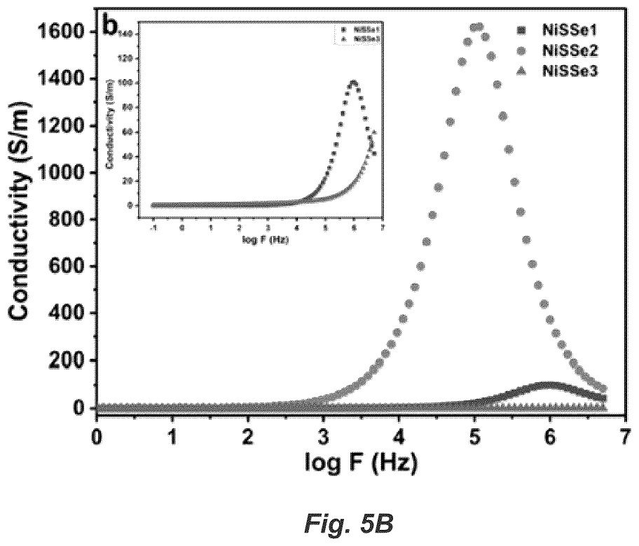

The electrochemical measurements of the as-prepared Ni_{0.6}Co_{0.4}SSe, Ni_{0.4}Co_{0.6}SSe, Ni_{0.5}Co_{0.5}SSe and CoSSe were carried out in a three-electrode system. The cyclic voltammogram was obtained at different scan rates from 10 mV/s to 100 mV/s with an increment of 10 mV/s at a limiting potential between 0V and +0.6V. The CV curves for Ni_{0.6}Co_{0.4}SSe, Ni_{0.4}Co_{0.6}SSe, Ni_{0.5}Co_{0.5}SSe and CoSSe are shown in the FIG. 4A at the scan rate of 10 mV/s. The sample CoSSe shows the absence of any redox reactions even at the low scan rate and the area of the CV curve is also very low compared to the others. It shows that only cobalt based chalcogenide system may not be as favorable as the binary systems with nickel. Ni_{0.5}Co_{0.5}SSe shows very clear oxidation peaks at 0.25 V, 0.3 V and 0.35 V and one reduction peak at 0.24 V. It evidences that the sample is not completely reversible or quasi reversible. Ni_{0.4}Co_{0.6}SSe has a broad oxidation peak at around 0.42 V and an almost absent reduction peak at 0.25 V making it also unfit. Ni_{0.6}Co_{0.4}SSe has peaks at 0.39 V and 0.16 V with a favorable difference between the oxidation and reduction peaks. The Ni_{0.6}Co_{0.4}SSe sample is quasi reversible with a good area. FIG. 4B shows the specific capacitance values calculated for the four samples and Ni_{0.6}Co_{0.4}SSe has the highest specific capacitance of 875 Fg⁻¹ at 10 mV/s. All the four samples were again subjected to constant current charge-discharge testing (GCD) as shown in FIG. 4C and the calculated specific capacitance is depicted in FIG. 4D. All the samples show a potential dependent charge storage curve, with the highest discharge time for Ni_{0.6}Co_{0.4}SSe and it attains a specific capacitance of 444 Fg⁻¹ with a current density of 1 Ag⁻¹. Ni_{0.6}Co_{0.4}SSe undergoes redox reactions and the mechanism is due to the redox conversion of Co³⁺ to Co⁴⁺ and Co²⁺ to Co³⁺ incase of cobalt and Ni²⁺ to Ni³⁺ and form intermediate products as [(Ni/Co)(S/Se)O] and [(Ni/Co)(S/Se)OH]. The influence of the ratio of the nickel and cobalt can be seen as the effect on the redox peaks. Based on all the observations Ni_{0.6}Co_{0.4}SSe was finalised to be the best performing sample among the nickel cobalt sulfoselenides.

The electrochemical measurements of the as-prepared NiS, NiSSe1, NiSSe2, and NiSSe3 were carried out by cyclic voltammetry technique in a three-electrode system using 1 M KOH as the aqueous electrolyte. CV analysis was done at various sweep rates between 10 mVs-1 and 100 mVs-1 at a limiting potential between-0.6 V and +0.6 V. As the scan rate increases, the specific capacitance decreases. The capacitance of only NiS was calculated to be 16 Fg⁻¹. When Se is incorporated into NiS, it shows well-defined redox peaks indicating the faradaic reaction initiated in the system. The specific capacitance values at 10 mVs⁻¹ sweep rate for NiSSe1, NiSSe2, and NiSSe3 are calculated to be 548 Fg⁻¹, 423 Fg⁻¹, and 401 Fg⁻¹ respectively as shown in FIG. 3A. From these results, the best performing sample was found as NiSSe1. To understand the electrical conductivity, a pellet was fabricated using NiSSe1, NiSSe2, and NiSSe3 powders and was tested in a four-probe setup. The electrical conductivity at 0.1 Hz was calculated to be 0.0366 Sm⁻¹, 0.646 Sm⁻¹ and 0.0021 Sm⁻¹ as shown in FIG. 3B. The increased conductivity has reduced with 3 mol incorporation of selenium (NiSSe3). The best performance was shown by NiSSe1 among NiSSe1, NiSSe2, and NiSSe3, nickel sulfoselenides.

### Example 3: HRTEM Analysis

The analysis confirmed the formation of sheet like morphology. The sheets are stacked and oriented in different planes. Usually, Van der Waals interlayer spacing lies between 3-6 Å. A large d-spacing of 5.52 Å and 6.25 Å is observed in several areas. The crisscross arrangement of the sheets can also be seen. The co-existence of nickel sulfoselenide and cobalt sulfoselenide is proved through this arrangement. The 2D Van der Waal's heterostructures are very flexible and the space between the sheets is doubled due to the evident stacking fault defect. This large d-spacing allows for the electrolyte ions to pass in and out of the electrode without having to undergo a torturous network. The combined effect of the interaction between sulfur and selenium and the similarity in nickel and cobalt has aided to the unique stacking of the nanosheets. Thereby more active sites are exposed and made available to facilitate the ion insertion or deinsertion. This ensures the high performance of the Ni_{0.6}Co_{0.4}SSe sample. The HRTEM images of the nickel sulfoselenide further confirm the formation of sheets. From the HRTEM pattern, the interlayer spacing of the nanosheets was calculated to be 2.9 Å, consistent with the XRD observations. Stacking fault was also observed in the HRTEM images. As Se is introduced, there is a mismatch in the size and also in the electronegativity. Although there could be a conductivity enhancement, the substitution modifies the morphology of nickel sulfide. The close stacking of the 2D layers is altered in nickel sulfide with Se incorporation, and there is an increase in the interlayer distance. The Se ions also enhance the electrostatic attraction between the nanosheets and the ions of the electrolyte. This in turn allows for more active Ni ion sites to be exposed favoring the redox charge storage.

### Example 4: Fabrication of Coin Cell

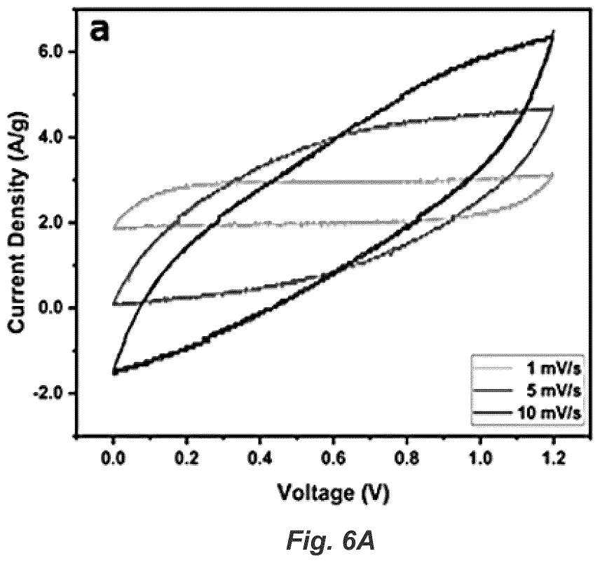

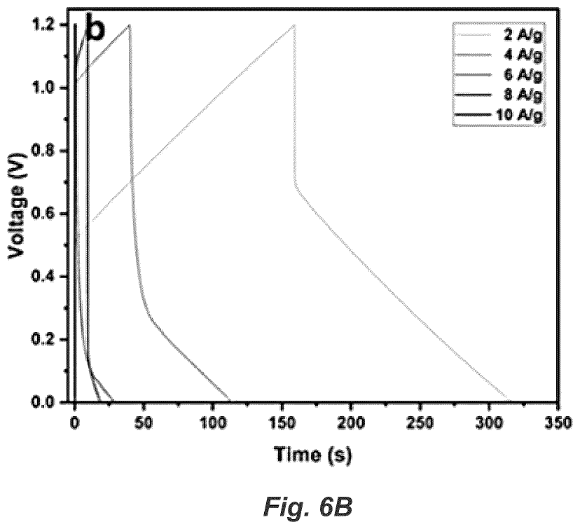

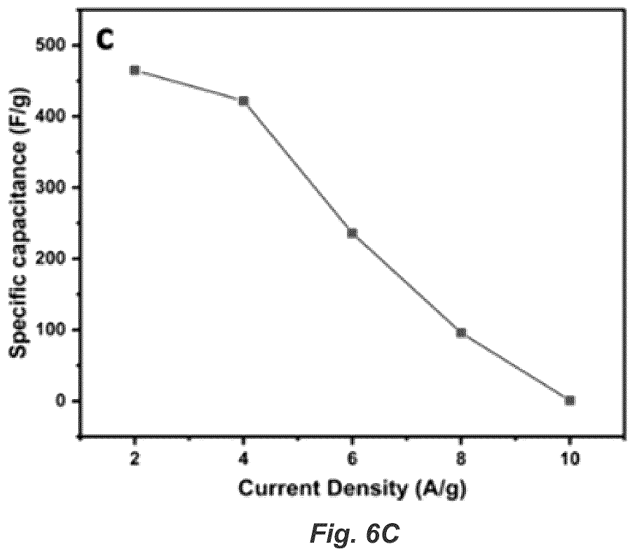

For fabrication of coin cell, the powdered sample of Ni_{0.6}Co_{0.4}SSe was transformed into an ink. The ink was then applied to carbon cloth electrode. After drying the sample at 80° C., the weights of the electrodes were measured. Similarly, two electrodes with a 1 cm² area were prepared to create a CR2032 coin cell. The mass loading was maintained at 0.5 mg per electrode with Whattman separator. For the gel electrolyte 1 M PVA/KOH was used. The CV (cyclic voltammogram) at different scan rates is represented in FIG. 6A and GCD curves at different current densities is represented in FIG. 6B, 464 Fg⁻¹ at 2 Ag⁻¹. FIG. 6C shows the capacitance calculated at different current densities for the Ni_{0.6}Co_{0.4}SSe coin cell. To evaluate the stability of the fabricated coin cell, continuous charge-discharge cycles were conducted at a rate of 5 Ag⁻¹ for 30,000 cycles, resulting in a retention rate of 99%. After completing the cyclic study, the cell, referred to as cell 1, was left in ambient conditions. The coin cell has an energy density of 31 Whkg⁻¹ and a power density of 759 Wkg⁻¹ at a current density of 2 Ag⁻¹. At a moderate current density of 6 Ag⁻¹, the power density is 4003 Wkg⁻¹.

An asymmetric cell was prepared with one electrode coated with Ni_{0.6}Co_{0.4}SSe active material and the other electrode coated with activated carbon. A very high mass loading of 15 mg was loaded on the electrodes. The specific capacitance of the asymmetric device named cell 2 at 10 mV/s was calculated to be 50 Fg⁻¹. The GCD measurements were repeated at various current densities. The GCD analysis was carried out at high current density of 10 A/g and over 60,000 cycles 87.54% retention was attained. The approximate 1% drop in the initial 100 cycles can be attributed to the intrinsic resistance and the sluggish kinetics due to the use of gel electrolyte. After which the cell offers a good performance and accounts to only 11% loss after the next 60000 cycles as tabulated in Table 1.

TABLE 1
Comparison of capacitance drop at 10 A/g after different cycles

| Cycle No. | Cp at 10 A/g | Drop in Cp |
|---|---|---|
| 1 | 38.25 | |
| 100 | 37.89 | 0.92% |
| 60000 | 33.48 | 12.46% |

After 2 years the cell 1, was again subjected to electrochemical testing. The cell offered a capacitance retention of 93% after two years and a drop of 23% from the initial testing. The coulombic efficiency is also retained above 90%.

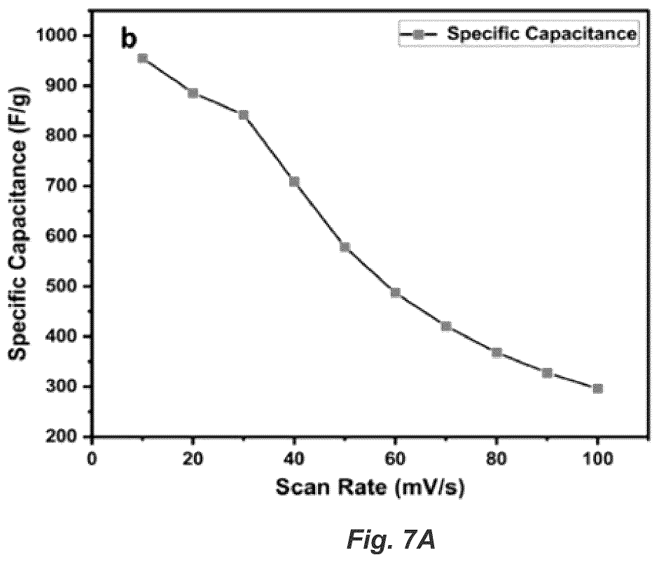

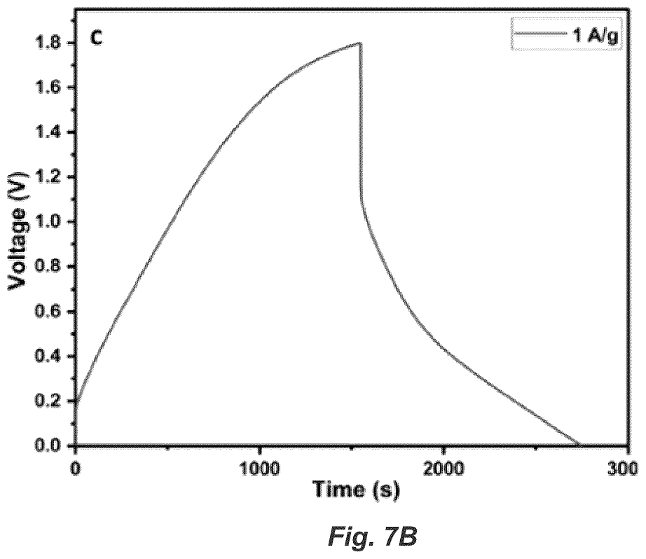

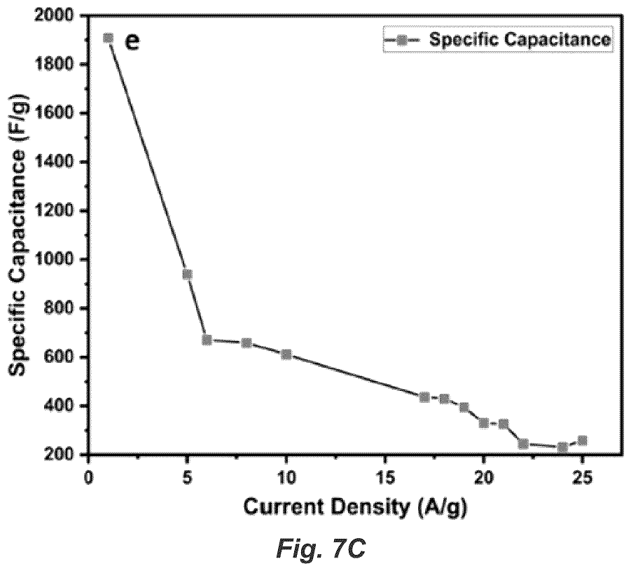

The NiSSe1 was used to fabricate a coin cell. The CV measurements were carried out by extending the limiting potential to the maximum for the gel electrolyte i.e., 1.8 V. The specific capacitance of the symmetric device at 10 mVs⁻¹ was calculated to be 955 Fg⁻¹. The CV (specific capacitance) measurements were repeated at various scan rates as shown in FIG. 7A. It can be seen that with an increase in the scan rates, the area under the CV curve decreases, while there is an increase in current. This is due to the diffusion component that dominated the charge storage in case of transition metal dichalcogenides. At higher scan rates, there is no room for diffusion and the observed CV curve is a result of mainly capacitive capacitance. FIG. 7B shows the GCD curve at 1 Ag⁻¹. FIG. 7C shows the specific capacitance calculated from the GCD curve. At a low current density of 1 Ag⁻¹, a capacitance of 1908 Fg⁻¹ is achieved as seen in FIG. 7C. Even at a high current density of 25 Ag⁻¹, a capacitance of 259 Fg⁻¹ was achieved.

To check the stability of the fabricated coin cell, continuous charge discharge cycles were done at 5 Ag⁻¹ for 60,000 cycles and it offered 100% retention. The main drawback of chalcogenide systems is the inevitable volume expansion which could lead to structural degradation affecting the stability of the supercapacitor. However, the Van der Waal interaction between the layers can become weak after long cycles compromising the fast reaction kinetics. But the selenium incorporation has complemented this property and the symmetric device showed 95% retention after 10,000 cycles at 25 Ag⁻¹. After this, the same device was tested over 18,000 cycles subsequently for charge-discharge and it exhibited 92% retention at 24 Ag⁻¹.

The shelf life of the fabricated cell was calculated. The coin cell was kept idle for 100 days in ambient environment after the cyclic studies and the shelf life of the cell was tested. At 10 Ag⁻¹, for 3000 cycles the device showed 100% retention in the initial capacitance. In any commercial supercapacitor a mass loading of 3-8 mg is highly recommended. Hence the same material was tested for higher mass loading of 3 mg in a three electrode set up using Ni-foam as the substrate. A specific capacitance of 146 F/g was achieved at 3 A/g. A symmetrical supercapacitor with high loading of 3 mg on each of the electrodes was also fabricated and it showed 85% retention after 60,000 cycles at a current density of 10 A/g with a specific capacitance value of 38 F/g. The electrode material after the cyclic study was washed and dried. It was taken for XPS analysis and there was no change in the material before and after cyclic study. A slight shift in the sulfur and selenium peaks was observed which is due to the weak Van-der Waal's interaction between the layers. The NiSSe active material's structural stability and electrochemical stability were thus ensured.

While the invention has been disclosed with reference to certain embodiments, it will be understood by those skilled in the art that various changes may be made and equivalents may be substituted without departing from the scope of the invention. In addition, many modifications may be made to adapt to a particular situation or material the teachings of the invention without departing from its scope, which should be as defined by the claims appended herewith.

1. A nickel cobalt sulfoselenide mixed chalcogenide supercapacitor, comprising:
Ni₁Co₁₋ₓSSe, where nickel and cobalt are in ratios of 6:4, 4:6, 5:5, 0:10, or 10:0 forming Ni_{0.6}Co_{0.4}SSe, Ni_{0.4}Co_{0.6}SSe, Ni_{0.5}Co_{0.5}SSe, CoSSe or NiSSe;
the sulfoselenides having a 2D Van der Waals layered structure of nanosheets with d-spacing in the range of 3 A^{∘} to 7 A^{∘}.

2. The nickel cobalt sulfoselenide mixed chalcogenide supercapacitor as claimed in claim 1, wherein the pore radius of the chalcogenide varies from 50 A^{∘} to 120 A^{∘}.

3. The nickel cobalt sulfoselenide mixed chalcogenide supercapacitor as claimed in claim 1, wherein the Ni_{0.6}Co_{0.4}SSe gives XRD peaks at 22.15°, 26.31°, 27.55°, 41.52°, 45.08°, 52.41°, 60.69°, 64.73° and 66.93°.

4. The nickel cobalt sulfoselenide mixed chalcogenide supercapacitor as claimed in claim 1, wherein the nickel cobalt sulfoselenide in the stoichiometry Ni_{0.6}Co_{0.4}SSe has a pore radius of 66.21 Å and a pore volume of 0.5381 ccg⁻¹ or more.

5. The nickel cobalt sulfoselenide mixed chalcogenide supercapacitor as claimed in claim 1, wherein the nickel cobalt sulfoselenide, Ni_{0.6}Co_{0.4}SSe has a surface area of 171.878 m²g⁻¹ or more.

6. The nickel cobalt sulfoselenide mixed chalcogenide supercapacitor as claimed in claim 1, wherein the surface areas of Ni_{0.4}Co_{0.6}SSe, Ni_{0.5}Co_{0.5}SSe and Ni₀Co_{1.0}SSe are 6.624 m²g⁻¹, 6.431 m²g⁻¹ and 5.525 m²g⁻¹ respectively.

7. The nickel cobalt sulfoselenide mixed chalcogenide supercapacitor as claimed in claim 1, wherein the nickel sulfoselenide, NiSSe gives XRD peaks at 19.55°, 20.30°, 22.17°, 27.19°, 30.50°, 59.05°.

8. A supercapacitor electrode based on nickel cobalt sulfoselenide claimed in claim 1, comprising:
powdered Ni₁Co₁₋ₓSSe having narrow pore size distribution transformed into an ink, and using carbon cloth or nickel foam as substrate.

9. The supercapacitor electrode as claimed in claim 8, wherein the Ni₁Co₁₋ₓSSe electrode formed from Ni_{0.6}Co_{0.4}SSe gives a specific capacitance of 464 Fg⁻¹ with a current density of 1 Ag⁻¹.

10. The supercapacitor electrode as claimed in claim 8, wherein the Ni_{0.6}Co_{0.4}SSe fabricated coin cell exhibits a retention rate of 99% for 30,000 cycles at a rate of 5 Ag⁻¹ and 87.54% retention over 60,000 cycles at a rate of 10 Ag⁻¹.

11. The supercapacitor electrode as claimed in claim 8, wherein the Ni₁Co₁₋ₓSSe electrode formed from NiSSe gives a specific capacitance of 1908 Fg⁻¹ with a current density of 1 Ag⁻¹ using PVA/KOH gel electrolyte and a specific capacitance of 259 Fg⁻¹ at a current density of 25 Ag⁻¹ and a capacitance retention of 95% after 10,000 charge-discharge cycles at 25 Ag⁻¹.

12. The supercapacitor electrode as claimed in claim 8, wherein the Ni_{0.6}Co_{0.4}SSe electrode has a shelf life after two years with a capacitance retention of 93% for over 1,00,000 cycles.

13. The supercapacitor electrode as claimed in claim 8, wherein the NiSSe electrode has a shelf life, with 100% retention after 3000 cycles at 10 A/g, of 100 days.

14. A method (100) of fabrication of nickel cobalt sulfoselenide/nickel sulfoselenide material, comprising:
providing Ni(NO₃)₂·6H₂O and Co(NO₃)₂·6H₂O in different ratios;
adding 4 g of NaOH and 300 mg of Na₂S flakes and grinding to form a mixture thereof;
adding ethylene glycol and selenium powder to form a mixture and homogenizing the mixture by grinding;
heating the homogenized mixture at 180° C. for about 6 hours and washing with double distilled water and ethanol;
drying at about 60° C. for 36 hrs to obtain a fine powder.

15. The method as claimed in claim 14, wherein the Ni(NO₃)₂·6H₂O and Co(NO₃)₂·6H₂O are taken in ratios 6:4, 4:6, 5:5, 0:10 and 10:0 to obtain the products Ni_{0.6}Co_{0.4}SSe, Ni_{0.4}Co_{0.6}SSe, Ni_{0.5}Co_{0.5}SSe, CoSSe and NiSSe for 6:4, 4:6, 5:5, 0:10 and 10:0 respectively.
